(19) United States
(12) Patent Application Publication
(10) Pub. No.: US 2008/0010257 A1
(43) Pub. Date: Jan. 10, 2008

(54) INTEGRATED VERTICAL SEARCH ENGINE AND CONTACT MANAGEMENT SYSTEM

(76) Inventors: Gary Tolfa, Newport Beach, CA (US); Eric M. Dilks, Thousand Oaks, CA (US)

Correspondence Address: CHRISTIE, PARKER & HALE, LLP, PO BOX 7068, PASADENA, CA, 91109-7068, US

(21) Appl. No.: 11/762,736

(22) Filed: Jun. 13, 2007

Related U.S. Application Data
(60) Provisional application No. 60/813,542, filed on Jun. 13, 2006.

(51) Int. Cl. G06F 7/00

(52) U.S. Cl. 707/3; 707/E17.014

(57) ABSTRACT

Integrated vertical search engines and contact management systems are disclosed. In many embodiments, the vertical search engine enables searching of information relating to real estate and the contact management system enables the association of contacts with the real estate information. One embodiment of the invention includes a server connected to a database. In addition, the database includes information concerning a piece of real estate, the database includes information concerning contacts, the database includes information concerning a relationship between a contact and another contact or a piece of real estate, the database includes information concerning a relationship between one contact and another contact, the information concerning contacts includes information concerning correspondence with contacts, the server is configured to provide an interactive user interface, interactive user interface is configured to enable searching of the database, and the interactive user interface is configured to enable modification of the database.

### CROSS REFERENCE TO RELATED APPLICATIONS

This application claims priority to U.S. Provisional Patent Application Ser. No. 60/813,542 filed Jun. 13, 2006, the disclosure of which is incorporated herein by reference in its entirety.

### BACKGROUND

The present invention relates generally to an integrated vertical search engine and contact management system and more specifically to an integrated vertical search engine and contact management system for use in the real estate industry.

Real estate brokers are often used in real estate transactions to identify potential buyers for real estate and to identify real estate suitable for acquisition by a prospective buyer. The information accumulated by a real estate broker concerning various properties and people with which the real estate broker has come into contact can be valuable during future transactions.

### SUMMARY OF THE INVENTION

Embodiments of the present invention provide an integrated vertical search engine and contact management system. In a number of embodiments, the integrated vertical search engine and contact management system contains information concerning real estate. In many embodiments, the integrated vertical search engine and contact management system is accessible via a web portal. Several embodiments include a client/server based system where multiple clients access the integrated vertical search engine and contact management system via a server. In many embodiments, at least some of the information in the database underlying the vertical search engine is shared by all users and at least some of the information is private to a specific user and/or group of users.

One embodiment of the invention includes a server connected to a database. In addition, the database includes information concerning an inventory, the database includes information concerning contacts, the database includes information concerning relationships between a contact and a piece of inventory, the database includes information concerning relationships between one contact and another contact, the server is configured to provide an interactive user interface, the interactive user interface is configured to enable searching of the database, and the interactive user interface is configured to enable modification of the database.

In a further embodiment, the information concerning contacts includes information concerning correspondence with the contact.

In another embodiment, wherein the inventory is real estate.

A still further embodiment includes a network, and a user computer connected to the network. In addition, the server is connected to the network.

In still another embodiment, the interactive user interface includes a series of web pages provided by the server to the user computer.

In a yet further embodiment, the server includes a server application, and the user computer includes a client application configured to buffer at least a portion of the information stored in the database.

Yet another embodiment includes, a telephone connected to the user computer. In addition, the server is configured to send information to the user computer enabling the user computer to dial a telephone number associated with a contact in the database.

In a further embodiment again, a contact can include a person, a partnership or a company.

In another embodiment again, a plurality of users can access the server, at least a portion of the information in the database is accessible to all users, and at least a portion of the information in the database is only accessible to a defined subset of users.

In a still further embodiment, the server is configured to generate a report file that can be downloaded onto the user computer.

An embodiment of the method of the invention includes storing information concerning pieces of inventory in a database, storing information concerning contacts in the database, storing information concerning a relationship between a piece of inventory and a contact in the database, storing information concerning a relationship between one contact and another contact in the database, and searching the database to locate information matching search criteria.

In a further embodiment of the method of the invention, the information concerning contacts includes information concerning correspondence with the contact.

In another embodiment of the method of the invention, the inventory is real estate.

In a yet further embodiment of the method of the invention, information concerning a piece of real estate includes information concerning the characteristics of a piece of real estate.

Yet another embodiment of the method of the invention includes interacting with a user via a graphical user interface including web pages.

A still further embodiment of the method of the invention includes automatically dialing a telephone using a telephone number associated with a contact in the database.

In still another embodiment of the method of the invention, a contact can include a person, a partnership or a company.

A further embodiment again of the method of the invention also includes enabling a plurality of users to access the database. In addition, at least a portion of the information in the database is accessible to all users and at least a portion of the information in the database is accessible to a defined subset of users.

Another embodiment again of the method of the invention also includes enabling a plurality of users to access the database, and providing a defined subset of users with the capability to modify the database.

Another further embodiment of the invention includes a server connected to a database. In addition, the database includes information concerning a piece of real estate, the database includes information concerning contacts, the database includes information concerning a relationship between a contact and another contact or a piece of real estate, the database includes information concerning a relationship between one contact and another contact, the information concerning contacts includes information concerning correspondence with contacts, the server is configured to provide an interactive user interface, interactive user interface is configured to enable searching of the database, and the interactive user interface is configured to enable modification of the database.

### BRIEF DESCRIPTION OF THE DRAWINGS

FIG. 1 is a schematic diagram of an integrated vertical search engine and contact management system in accordance with an embodiment of the present invention.

FIG. 2 is a table showing types of information concerning real estate stored in an integrated vertical search engine and contact management system in accordance with an embodiment of the present invention.

FIG. 3 is a table showing the types of contact information stored in an integrated vertical search engine and contact management system in accordance with an embodiment of the present invention.

FIG. 4 is a table showing the types of relationship information relating to the ownership of a property stored in an integrated vertical search engine and contact management system in accordance with an embodiment of the present invention.

FIG. 5 is a table showing the types of association information linking two contacts that is stored in an integrated vertical search engine and contact management system in accordance with an embodiment of the present invention.

FIG. 6 is a flow chart showing a process that can be used by a client in accordance with an embodiment of the present invention to respond to a user request to retrieve information from a database.

FIG. 7 is a flow chart showing a process that can be used by a server in accordance with an embodiment of the present invention to respond to an information request received from a client.

FIG. 8 is a flow chart showing a process that can be used by a database in accordance with an embodiment of the present invention to respond to an instruction to retrieve information.

FIG. 9 is a screen shot showing fictitious contact information in accordance with an embodiment of the invention.

FIG. 10 is a screen shot showing fictitious property information in accordance with an embodiment of the invention.

FIG. 11 is a screen shot showing a cold call center feature of a user interface in accordance with an embodiment of the present invention.

### DETAILED DESCRIPTION OF THE INVENTION

Turning now to the drawings, an integrated vertical search engine and contact management system is shown. In many embodiments the integrated vertical search engine and contact management system is accessed via a web site. In a number of embodiments an integrated vertical search engine is implemented using a client/server arrangement. In several embodiments, the vertical search involves searching a database of information relating to a specific defined subject area. Users can add information to the database. In several embodiments, at least a portion of the database is accessible by all users and at least another portion of the database contains private information, access to which is restricted to a single user or a designated group of users.

Overview

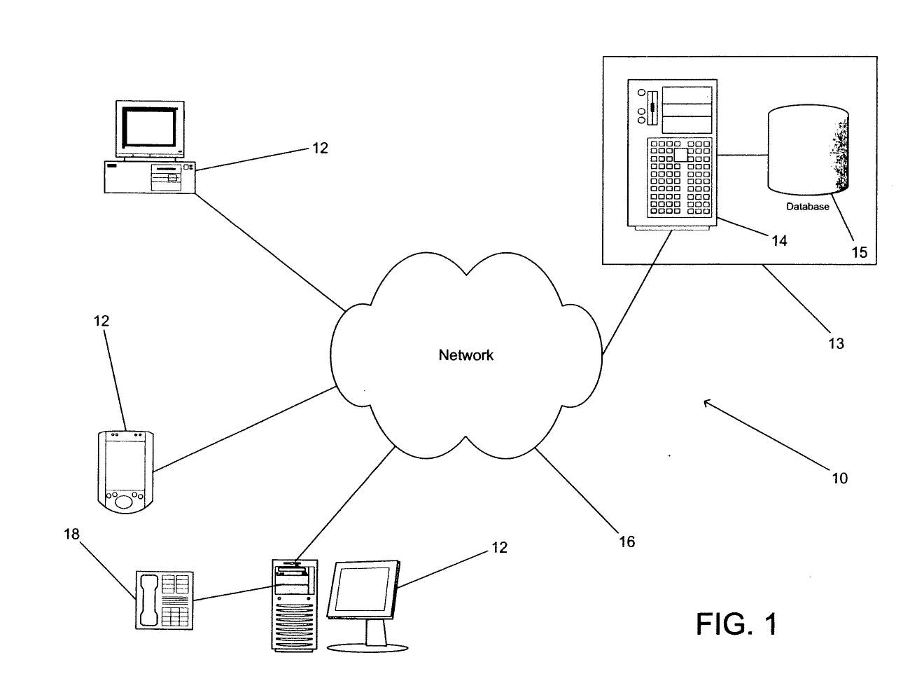

An integrated vertical search engine and contact management system is shown in FIG. 1. The integrated vertical search engine and contact management system includes a number of computing devices 12 that are connected to an integrated vertical search engine and contact management system 13 via a network 16. The integrated vertical search engine and contact management system is implemented as a server 14 and a database 15. One or more of the computing devices 12 can be connected to a telephone 18.

The computing devices 12 can be any form of computing device including a personal computer, portable computer, cell phone and/or personal digital assistant. The computing devices are equipped with software that enables display of a web page provided by the server 14. The web page provides a user interface through which a user can interact with the interactive search engine and contact management system 13. As will be discussed further below, interactions between the server and the computing device enable the user to perform searches of the database 15, and/or modify the database. In a number of embodiments, the functions that can be performed by the user are dependent upon the user's privileges with respect to the interactive vertical search engine and contact management system. In several embodiments, a guest user or visitor is able to perform searches of generally available information, and members of the site or registered users are able to perform searches of a larger set of information and modify the database in predetermined ways.

The Integrated Vertical Search Engine and Contact Management System

As discussed above, many embodiments of integrated vertical search engines and contact management systems include a server 14 and a database 15. The server acts as an interface between users and the database. The database 15 typically contains information concerning the vertical that can be searched using the vertical search engine and contact information. In a number of embodiments, the vertical is an aspect of the real estate market such as commercial real estate. For embodiments within the commercial real estate vertical, the database includes information concerning various pieces of real estate. The real estate information is integrated with contact information in a form that is searchable. The integrated information enables contacts (i.e. people, organizations, corporations and other entities) to be associated with the information from the vertical.

The combination of the vertical search capabilities and the contact management capabilities of the system enable users to locate relevant information and then the most appropriate person with whom to follow up concerning the located information. As is discussed below, the system does not simply provide contact information. The integrated contact management system enables the tracking of telephone discussions and correspondence between the user and various contacts identified within the database. In verticals such as the real estate industry, a contact may be associated with numerous properties and records concerning correspondence with the contact can be extremely useful in facilitating future transactions.

Although the following discussion describes the database as storing information concerning real estate and information concerning contacts, embodiments of systems adapted for industries other than the real estate industry can contain information concerning any type of inventory integrated with contact management information.

Real-Estate Information

Information concerning real estate typically refers to information that describes any characteristic of a piece of real property. Characteristics can include the location of the property, the date on which the property was last sold, the amount the property was purchased for by the property's current owners, the amount of money owed to lenders on the property, the property tax liability of the property, etc.

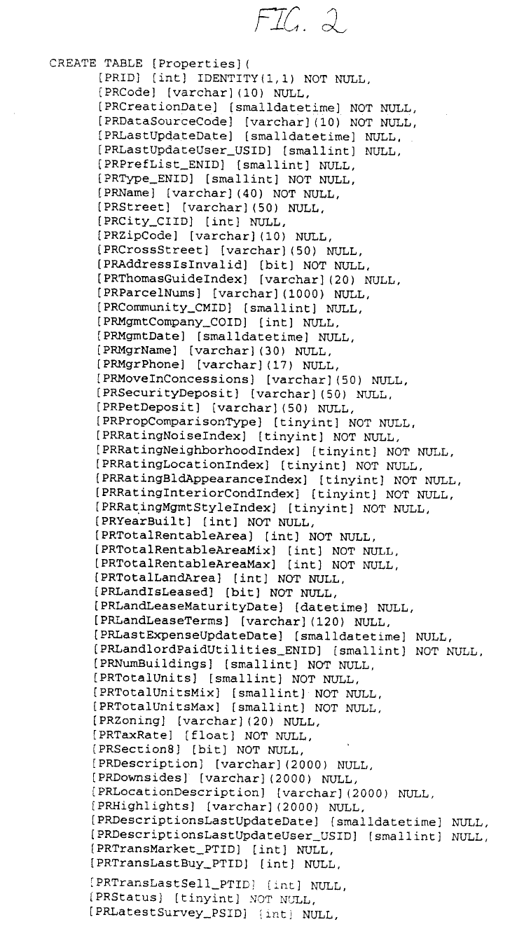

An example of types of information concerning real estate that can be stored in the database is shown in the table in FIG. 2. The embodiment shown in FIG. 2 includes information concerning the address of the property (cross referenced to a street directory), information concerning the property manager, ratings of the desirability of the property (includes separate ratings for noise, appearance, location, etc.), the age of the building, rents, market rents, lot size, number of units, zoning, tax rate, any applicable rent control statutes, information concerning previous sales and various other types of descriptive information. The information that can be stored in the database is in no way limited and can reflect the information requirements of the users accessing the database.

Contact Information

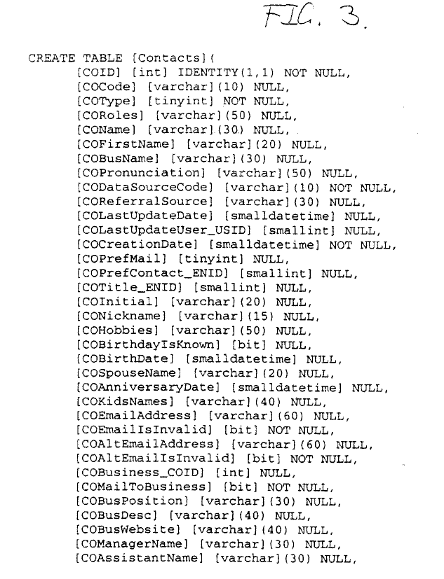

As discussed above, the database 15 includes integrated contact information. Contacts can be people, partnerships, companies or any other type of organization. Information that can be particularly useful to store in the database with respect to a contact is information concerning correspondence between a user and a contact. An example of the types of information concerning contacts that can be stored in the database is shown in FIG. 3. The illustrated embodiment includes information concerning the name of the contact, any associated business, name pronunciation, information concerning any referral, address, telephone and email information, and birthdays, hobbies and spousal information. As with the information concerning real estate, discussed above, there is essentially no limit on the types of information that can be stored with respect to contacts in the database.

Integration of Real Estate and Contact Information

In many embodiments, integration between information concerning real estate and contact information is achieved by storing real estate and contact information in a way that reflects relationships that may exist between a contact and a property or between a first contact and a second contact. In a number of embodiments, the real estate information and contact information are stored using a relational database management system or a SQL database management system. Both of these database management systems provide a framework for expressing information concerning the attributes of pieces of real estate and contacts and expressing information concerning the relationships between pieces of real estate and contacts and relationships between contacts. Examples of relationships that can be expressed include linking a contact with a property on the basis that the contact has an ownership interest in a property. Another example of a relationship involves linking one contact to another to reflect a business relationship such as participation in a partnership or joint ownership or a property.

Expressing Relationships Between Properties and Contacts

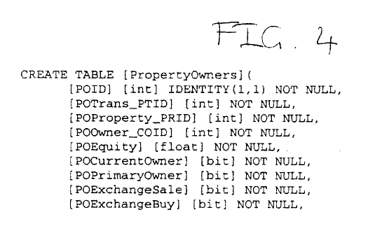

An example of the manner in which a relationship between a contact and a property owner can be defined is shown in FIG. 4. The illustrated relationship identifies a property and an associated contact. In a number of embodiments, different types of associations between owners and properties can exist. For example, an association can be used to identify that a contact formerly owned a property, loaned money secured by the property or was interested in purchasing the property in the past. As with other aspects of this system, there is essentially no limit on the types of relationships between properties and contacts that can be represented within the database.

Expressing Relationships Between Contacts

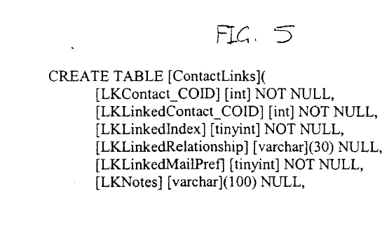

An example of the manner in which a relationship between different contacts can be represented is shown in FIG. 5. The illustrated relationship identifies a first contact and an associated contact. In many embodiments, the creation of a link between a first contact and a second contact can automatically result in the creation of a reverse link between the second contact and the first contact.

The user interface provided by the server enables the user to break down a large ownership entity into smaller more manageable parts. In many embodiments, individual contacts are designated with a role and a contact can have multiple roles. A list of a contact's roles can be maintained and added to as required. Examples of roles include investor, agent, broker, management company, title officer and/or lender. Within each role a contact can be designated a business or an individual. In this way, multiple partners or employees can be interrelated within a company. In many embodiments, any contact can be associated with either another contact or an association that is tied strictly to a particular owner. With this flexibility, a business with multiple separate associations can be represented and each association can be designated to receive mailings, phone calls and/or emails. As with other aspects of this system, there is essentially no limit on the types of relationships between different contacts that can be represented within the database.

Accessing the Database

As discussed above, many embodiments of integrated vertical search engines and contact management systems use servers to coordinate interactions between a user and the database. Using a web browser on any computing device (including a phone handset) the user can provide instructions to the server. The instructions can cause the server to perform a search of the database in accordance with search parameters provided by the user. In many instances, the user enters search parameters in a preformatted search template provided in a web page by the server. In other embodiments, the user can access information within the database using an index that is also provided in a series of web pages by the server. In addition to obtaining information form the database, the server enables the user to modify the database. The modifications can involve providing additional information, correcting incorrect information or deleting information that is no longer accurate. In a number of embodiments, the modification of the database is also coordinated using templates provided by the server. The server determines the operations to perform with respect to the database using all of the information received from the user via the server. In instances where the database returns information in response to a request from the server, the server formats the information into a web page to supply to the user.

In a number of embodiments, the operations that are able to be performed by a specific user are determined by access privileges associated with the user. For example, categories of users can be defined such as guests, registered users, premium users and administrators. In a number of embodiments, the differentiation between user categories are designed to encourage users to pay subscriptions in order to access more extensive sets of information and features. In one embodiment, guests are simply able to perform searches, registered users can perform searches and modify the database in limited ways, premium users are able to perform searches, utilize contact management features, form groups, share private information between the group and modify the database in more extensive ways, and administrators have unlimited rights to modify the database and regulate the system.

Modification of Database

In many embodiments, the information contained in the database comes from a number of sources. For example, basic real estate information can be provided by a first entity such as a commercial provider. The first entity could also provide contact information. The basic information can then be supplemented with information collected by users of the system. In many instances the users may wish to share the information. One such example would be when the general information (such as the number of bedrooms on a property) provided by the commercial provider is inaccurate or requires updating. When users wish to share information with other users, the user can modify the database accordingly. In the real estate vertical, examples of such modifications include notifying other users that a particular property is listed for sale. Another example of a useful modification is the association of a listing broker (i.e. a contact) with a particular property that has been listed for sale. In both the real estate and other verticals, modifications to other types of information within the database can be useful to users of the integrated vertical search engine and contact management system as a whole.

Separation of Public and Private Data within Database

In many instances information added to a database in accordance with an embodiment of the invention can be valuable to an individual user and the user may not wish to share the information with other users. Such information can include information concerning the user's contacts and/or information collected in relation to specific properties such as the price at which the owner is willing to sell the property. In many integrated vertical search and contact management systems in accordance with embodiments of the present invention, the database stores information as being either publicly accessible information or restricted access information. In this way, access to information can be restricted to a single user or a defined group of users. In several embodiments, various access priorities are assigned.

Managing Contacts

As discussed above, the database can include a set of generally accessible contact information. That information can be supplemented with private contact information. Many integrated vertical search engine and contact management systems in accordance with the present invention also enable tracking of correspondence with clients. In a number of embodiments, users are able to access client contact information via a user interface provided by the server. At the user instruction, the user's computing device can initiate a telephone call and the user interface prompts the user to input information concerning content, outcome and/or any follow up required. In circumstances where the outcome of the call was that the contact could not be reached, the contact can be added to a call back list. The call back list can then be used to retrieve information when the contact returns a call.

Cold Call Center

Integrated vertical search engine and contact management systems in accordance with embodiments of the invention can include a user interface feature that can be referred to as a “Cold Call Center”. The Cold Call Center is a user interface that provides an efficient source of information for performing cold calls in relation to business activities (such as an attempt to sell a piece of real estate). In one embodiment, a user searches the contact database using the search capability described above. Once a search is completed, the search results can be formed into a list that can be sorted using any number of fields containing information associated with the search results. The user interface offers the ability to display all the vital information related to a contact prior to the user calling the contact. Once the call is complete the user can enter information documenting the result of the cold call. In many embodiments, notes are entered as part of the documentation and a reminder is set up in relation to any future follow-up calls. If no contact is made and a message is left, then a new call back date along with information identifying the contact is added to a list of contacts to which calls should be returned. As discussed above, keeping information readily available can greatly assist a user in the event that the contact returns the user's call.

Managing Property Information

Systems in accordance with several embodiments of the invention include a user interface that enables the management of multiple properties. In addition to displaying information concerning the physical characteristics of a property, user interfaces that also provide financial information such as rent rolls, expense data and loan history. Such a user interface typically includes core information concerning the property such as address, parcel number, number of units, age and the most recent sale data. In addition, the user interface conveys important information such as unit mix, amenity information, photographs, owners, lists and correspondence.

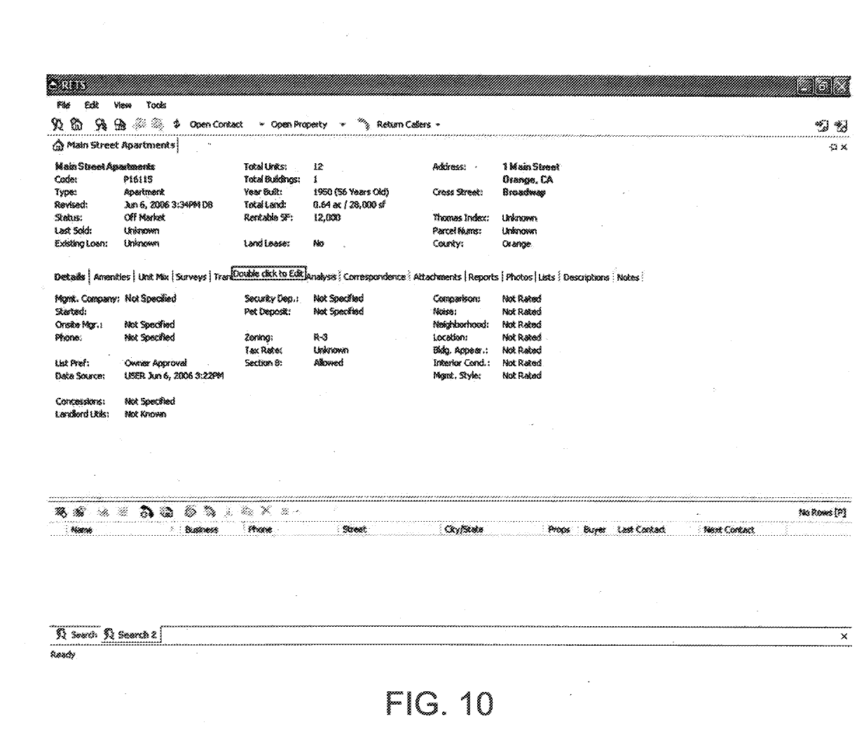

A screen shot of a user interface in accordance with an embodiment of the invention is shown in FIG. 10. In the illustrated embodiment, the screen is divided into an upper and lower portion. The upper portion consists of important core information including address, parcel number, number of units, age and the most recent sale data. The tabs consist of other property data arranged to allow easy access and editing. In a number of embodiments, the tabs organize important information such as unit mix, amenity information, photographs, owners, lists and correspondence. In other embodiments, tabs are not used or are used to access different categories of information concerning a property. The current and historical sale and rental data is typically recorded in such a way that trends of sale and rents can be gathered and reviewed very easily for any specific property or group of properties.

Rent Rolls and Expense Data

As discussed above, many embodiments of the present invention include the ability to provide users with rent rolls and expense data. A rent roll is typically a full listing of the rents for each unit on a multiunit property. In addition, expense information can be tracked using a virtually limitless number of different expense categories. The various expenses can be categorized in meaningful ways such as whether the expense should be treated as maintenance and repair for tax purposes or whether the expense should be treated as a capital improvement for tax purposes. As discussed previously, the information provided by a system in accordance with embodiments of the invention is not limited to those examples provided above.

Loan History and Property Ownership History

In several embodiments, the financial information provided by the user interface includes the loan history of the property and/or loan history of one or more owners of the property. In a number of embodiments, the information concerning loan history is acquired via manual data entry. In other embodiments, the information is provided by integration of third party data into the integrated vertical search engine and contact management system. In addition to loan history, the user interface can also display information concerning previous owners of the property, previous rent surveys for the property and/or other reports or transactions involving the property.

Integration with Mapping Software

As discussed above, many embodiments of the present invention include detailed information concerning listed properties. In many embodiments, the detailed information is used to access services provided by third parties. An example of such an application is the linking of address information with mapping, satellite photographs and/or streetscape photographs provided via a third party. In other embodiments, the mapping, satellite photographs and/or streetscape photographs are incorporated into the integrated vertical search engine and contact management system.

Monitoring on Market Properties

Many embodiments of the invention track whether properties are listed for sale. The tracking typically involves tracking the listing date, when the property enters escrow, predicted closing data and whether the property closes. In several embodiments, information concerning property listings or escrow is entered manually and/or automatically integrated using information provided by a 3rd party service.

Display Information Relevant to Purchasing Property

In addition to providing information concerning the physical nature of a property and financial information associated with a property, many embodiments of integrated real estate vertical search engine and contact management systems in accordance with the present invention include the capability of simulating the financial characteristics of purchasing a property under a variety of different scenarios. In several embodiments the scenarios can be presented concurrently to advise a contact on the likely financial implications of, for example, investing differing amounts of capital, increasing rents, decreasing expenses and/or securing different types of financing. Essentially any number of different parameters can be entered into a simulation (often being drawn from the baseline information of the property itself) and these simulations used to provide different financial scenarios. The simulations provided by systems in accordance with embodiments of the invention are not limited to those described above.

Comparable Properties

Another feature of many embodiments is the ability to identify comparable properties from within the integrated real estate vertical search engine and contact management system. The comparable properties can be useful as a basis for estimating likely rents and/or capital appreciation. In many embodiments, comparable properties are determined by searching the integrated vertical search engine and contact management system using at least the geographic location of the property as a search parameter. In several embodiments, physical characteristics of the property such as size and/or number of units are also used as search parameters to identify comparable properties. In a number of embodiments, a predetermined set of search criteria are used to ascertain the identity of comparable properties and the predetermined set of search criteria can be a default set of criteria or a set of criteria determined by the user.

In other embodiments, the user interface enables a search to be performed for locating comparable properties, and specific properties can be selected and the results stored as a list or in another form for later retrieval by the user. The search can be restricted to Sales and/or On-market comparables. The ability to store results can enable rapid retrieval of the information should the information be useful in the preparation of a future proposal relating to the property.

Report Generation

In addition to generating different financial scenarios and comparable properties, integrated vertical search engine and contact management systems in accordance with the present invention are also capable of generating reports. In many embodiments, the reports are automatically generated as electronic files for printing or electronic distribution. In other embodiments, data required to generate reports can be directed to templates in other applications (such as spreadsheets or word processing applications) that can then be used to manipulate the data to provide a suitable report. In several embodiments, the user is provided with a number of different options concerning report formats.

Interoffice Task Coordinator

Many embodiments include a user interface possessing a task coordination feature. The task coordination feature enables a first user to generate a task for completion by either the first user or another user. A task typically includes an activity to be performed (such as a phone call, a data update or a letter to send out). The person that assigned the task and the person to whom the task is assigned. The task manager enables a user to track the tasks that have been assigned to the user and to track the progress of tasks assigned by the user. In many embodiments, the assignment of a task can be accompanied by a notification delivered for example by email or by a text message.

Client/Server Architecture

A variety of architectures can be used in the implementation of an integrated vertical search engine and contact management system in accordance with embodiments of the invention. The embodiment discussed above uses a web based architecture that relies on a web server to provide a user interface via a user's web browser. Another architecture in accordance with the present invention is the use of a client/server architecture. In the client/server architecture, each computing device typically hosts client software that enables the computing device to communicate with one or more servers 14. Server software installed on the servers enables communication with the clients 12 and also enables access to information stored in one or more databases. In addition to communicating with the server, the client can buffer recently accessed information and generate a user interface.

Accessing the Database Using a Client/Server Architecture

A user of an integrated real estate vertical search engine and contact management system in accordance with embodiments of the present invention uses client software installed on the user's computing device 12 to communicate with a server 14 to gain access to information stored on a database 15. In many applications, the speed with which information is retrieved can be extremely important to the user. For example, a user that receives a call from a particular contact will want to access information concerning the contact rapidly so as to be able to discuss properties relevant to the contact. In many embodiments, the client software increases the speed with which data is retrieved by caching information on the user's computing device 12. The cached information enables the client to reduce data access time for recently accessed information.

Processes for Accessing Information

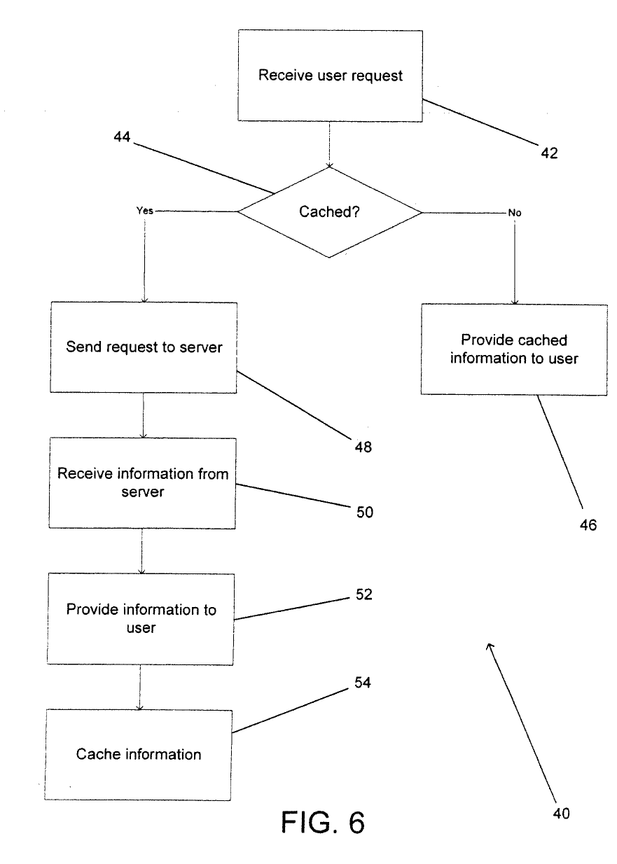

An embodiment of a process for retrieving information from an integrated vertical search engine and contact management system using a client application installed on a computing device connected to a server via a network in accordance with an embodiment of the present invention is shown in FIG. 6. The process 40 includes receiving (42) a request from a user to access information and determining (44) whether the information is available in a local cache. If the information is available, then the information is provided (46) to the user. If the information is not available, then a request (48) is sent to a server via a network connection. When a response is received (50) containing the requested information, the information is provided (52) to the user and stored (54) in the local cache.

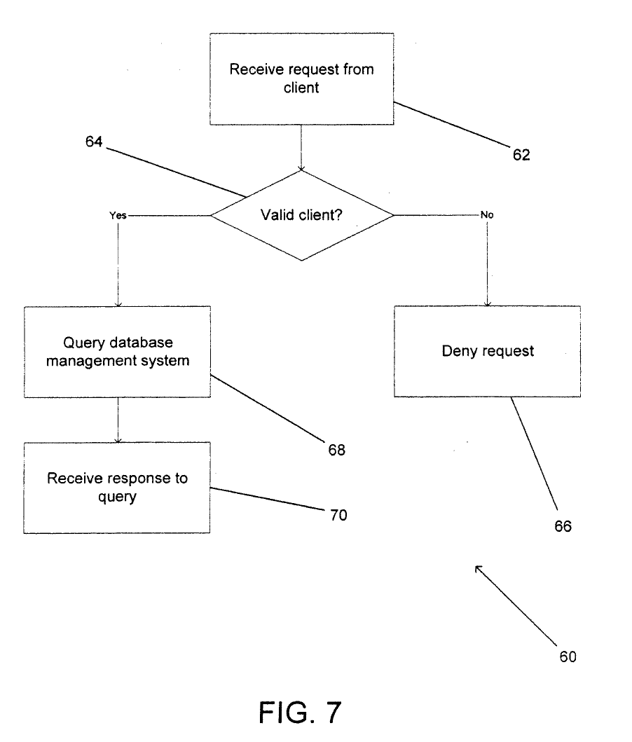

A process that can be used by a server in accordance with an embodiment of the present invention to respond to requests for information in accordance with the present invention is shown in FIG. 7. The process 60 includes receiving (62) a request for information from a client and verifying (64) that the client is valid and is entitled to access the information requested. If the client is invalid or is not authorized to access the information requested, then the server can respond (66) to the client denying the information request. If the request is received from a valid client and the client is authorized to access the requested information, then the server instructs (68) the database management system to retrieve the requested information. When the database management system returns (70) the requested information, the information is forwarded (72) to the client via the network.

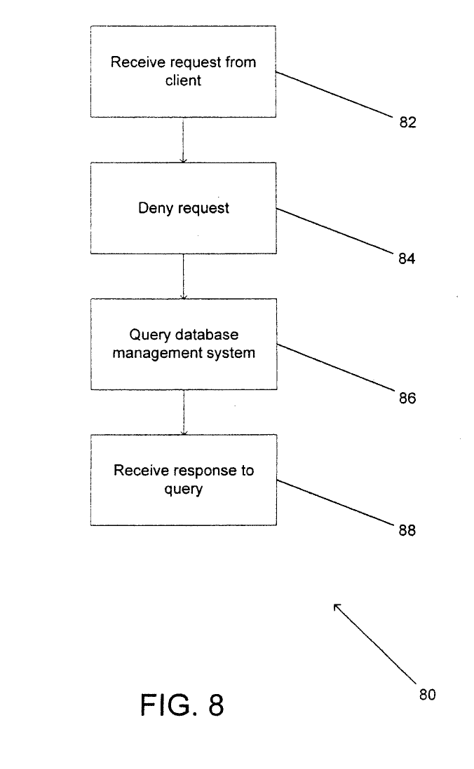

A process that can be used by a database management system in accordance with an embodiment of the present invention to retrieve information from a database is shown in FIG. 8. The process 80 includes receiving (82) an instruction to retrieve information and determining (84) the search to be performed in response to the instruction. In many embodiments, the search to be performed will depend upon information contained within the instruction that is indicative of the portions of the database that are to be searched. For example, the instructions can identify the client requesting the information retrieval and the database can contain information concerning the information within the database that can be accessed by that particular client. The access information can then be used to constrain the search associated with the information retrieval to only those portions of the database accessible by that client. Once the portion of the database to be searched is determined, then a search is performed (86) and the search results are provided (88) in response to the instruction to retrieve information.

The User Interface

In many embodiments, the client software located on a user's computing device 12 includes a graphical user interface. The graphical user interface enables the visual display of information and an interface that the user can use to obtain additional information. In many instances, the user's interactions with the user interface will result in the user interface generating information requests that are provided to a server 14. For example, a user that selects a particular contact may wish to view properties owned by the contact. In one embodiment, the user can request this information by selecting a tab associated with the contact. Selection of the tab results in the graphical user interface generating an information request as discussed above. The information retrieved either from the client's cache or from the database via the server can then be used to populate a graphical display that presents the information to the user.

As discussed above, integrated database and contact management systems in accordance with embodiments of the present invention can be constructed around one or more relational databases that maintain property and contact data. In several embodiments, the main contact and property databases have many underlying databases that contain fields that draw upon a finite number of values. In the graphical user interface, these fields can be represented using drop down selections. In many embodiments, the user possesses the ability to add values to a field and the software automatically updates the graphical user interface and/or the database to include the additional values. In a number of embodiments, fields that are either bounded or unbounded can utilize a type ahead feature that attempts to predict the value being entered by a user by comparing the information input to known values for the field.

Navigation of a user interface in accordance with an embodiment of the present invention can be performed using a combination of a keyboard and a mouse. Although in other embodiments, other user input devices can be utilized such as a stylus (for example on a PDA) or using the key pad of a cell phone or using a cell phone microphone as part of a voice activation/recognition system. In many embodiments, the user interface utilizes tab functionality and type ahead technology so as to provide ergonomic usage of various input devices. In addition, menus can be used to provide easy access to searches, interoffice task systems and a cold call center. In many embodiments, all of the features described above with respect to a web based implementation of the invention are provided to users via the client software. The following are specific examples of features provided via the client software.

Managing Contacts

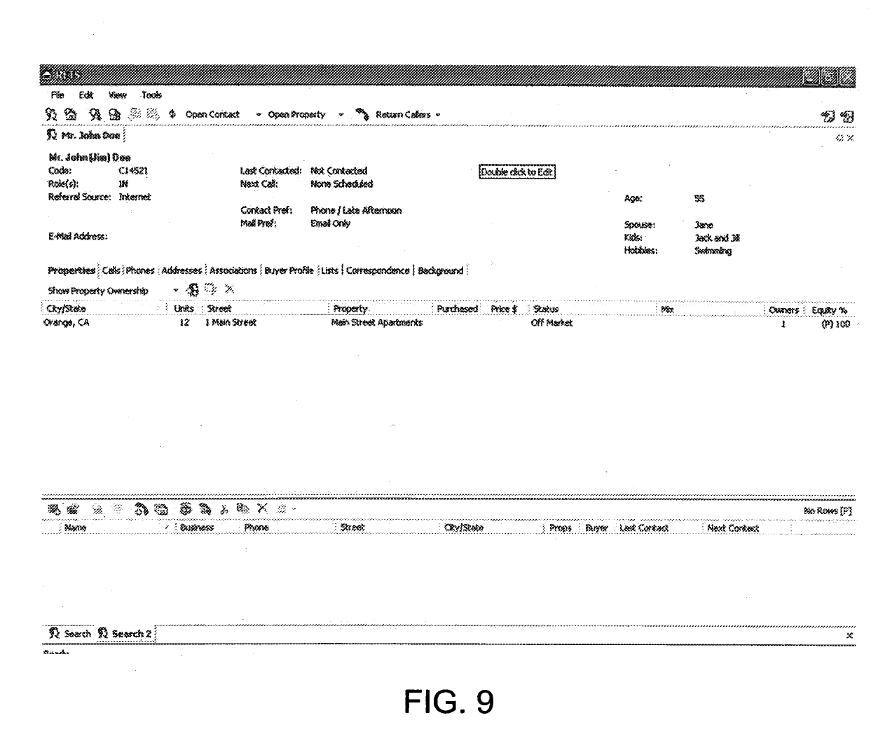

As discussed above, the ability to manage contacts can be an important component of an integrated vertical search engine and contact management system. A screen shot of a user interface provided by a client application installed on a computing device in accordance with an embodiment of the present invention for managing contacts is shown in FIG. 9. The user interface of the client application enables the user to break down a large ownership entity into smaller more manageable parts. In many embodiments, individual contacts are designated with a role and a contact can have multiple roles. A list of a contact's roles can be maintained and added to as required. Within each role a contact can be designated a business or an individual. In this way, multiple partners or employees can be interrelated within a company. In many embodiments, any contact can be associated with either another contact or an association that is tied strictly to a particular owner. With this flexibility, a business with multiple separate associations can be represented and each association can be designated to receive mailings, phone calls and/or emails.

Using the user interface, contacts can be associated with a number of properties and the user interface can display all properties that a contact owns or used to own. In many embodiments, the user interface offers the ability to click through to the property from a list of properties provided in a display.

A contact management user interface in accordance with the present invention can also enable searching of contacts based on the contents of any number of fields used to contain information concerning the contacts. A particularly useful search is to set up a list of buyer parameters when searching for a contact likely to be interested in a newly listed property.

The ability within many embodiments to record information concerning correspondence with contacts also enables users to obtain productivity information with respect to other users in a particular group. For example, a manager can track the number of calls made by a particular user and the outcomes arising from each of the calls.

Managing Properties

The user interface of the client software can also enable the management of one or more properties. A screen shot of a user interface provided by a client application on a computing device in accordance with an embodiment of the invention is shown in FIG. 10. In the illustrated embodiment, the screen is divided into an upper and lower portion. The upper portion consists of important core information including address, parcel number, number of units, age and the most recent sale data. The tabs consist of other property data arranged to allow easy access and editing. In a number of embodiments, the tabs organize important information such as unit mix, amenity information, photographs, owners, lists and correspondence. In other embodiments, tabs are not used or are used to access different categories of information concerning a property. The current and historical sale and rental data is typically recorded in such a way that trends of sale and rents can be gathered and reviewed very easily for any specific property or group of properties.

Tracking Mailings/Emails/Telephone Calls

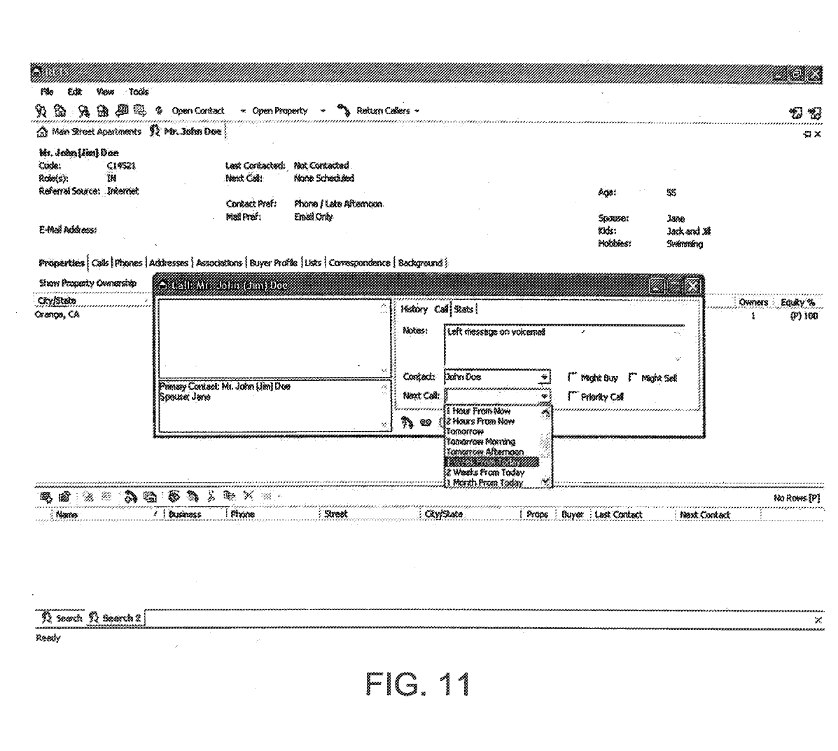

As discussed above, a Cold Call Center can be used to manage correspondence with a contact. In addition, the user interface of the client software can be used to track various correspondence made with a client or by an individual user. A screen shot of a user interface in accordance with the present invention showing information concerning a telephone call with a fictitious contact John Doe is shown in FIG. 11.

Although many embodiments of integrated vertical search engine and contact management system are possible, an integrated vertical search engine and contact management system in accordance with one embodiment of the present invention developed for a Microsoft Windows platform can be written in the C sharp programming language and run under Microsoft dot net 2.0. In addition, embodiments can be built using a multi-tiered architecture utilizing a Microsoft Sequel Server 2005.

While the above description contains many specific embodiments of the invention, these should not be construed as limitations on the scope of the invention, but rather as an example of one embodiment thereof. For example, the above system can be used as a self contained system located on a single computer. Alternatively, the system can be used as a more highly distributed system. In a number of embodiments, the system can use a pier architecture as opposed to a client/server architecture. In addition, the various fields of information outlined above and the specific vertical of real estate are only provided as examples. Other fields of information can be used and the system can have applications within other verticals. Accordingly, the scope of the invention should be determined not by the embodiments illustrated, but by the appended claims and their equivalents.

What is claimed is:

1. An integrated vertical search engine and contact management system, comprising:
a server connected to a database;
wherein the database includes information concerning an inventory;
wherein the database includes information concerning contacts;
wherein the database includes information concerning relationships between a contact and a piece of inventory;
wherein the database includes information concerning relationships between one contact and another contact;
wherein the server is configured to provide an interactive user interface;
wherein the interactive user interface is configured to enable searching of the database;
wherein the interactive user interface is configured to enable modification of the database.

2. The integrated vertical search engine and contact management system of claim 1, wherein the information concerning contacts includes information concerning correspondence with the contact.

3. The integrated vertical search engine and contact management system of claim 1, wherein the inventory is real estate.

4. The integrated vertical search engine and contact management system of claim 1, further comprising:
a network;
a user computer connected to the network; and
wherein the server is connected to the network.

5. The integrated vertical search engine and contact management system of claim 4, wherein the interactive user interface includes a series of web pages provided by the server to the user computer.

6. The integrated vertical search engine and contact management system of claim 5, wherein:
the server includes a server application; and
the user computer includes a client application configured to buffer at least a portion of the information stored in the database.

7. The integrated vertical search engine and contact management system of claim 4, further comprising:
a telephone connected to the user computer;
wherein the server is configured to send information to the user computer enabling the user computer to dial a telephone number associated with a contact in the database.

8. The integrated vertical search engine and contact management system of claim 1, wherein a contact can include a person, a partnership or a company.

9. The integrated vertical search engine and contact management system of claim 1, wherein:
a plurality of users can access the server;
at least a portion of the information in the database is accessible to all users; and
at least a portion of the information in the database is only accessible to a defined subset of users.

10. The integrated vertical search engine and contact management system of claim 4, wherein the server is configured to generate a report file that can be downloaded onto the user computer.

11. A method of locating inventory information and contact information, comprising:
storing information concerning pieces of inventory in a database;
storing information concerning contacts in the database;
storing information concerning a relationship between a piece of inventory and a contact in the database;
storing information concerning a relationship between one contact and another contact in the database; and
searching the database to locate information matching search criteria.

12. The method of claim 11, wherein the information concerning contacts includes information concerning correspondence with the contact.

13. The method of claim 11, wherein the inventory is real estate.

14. The method of claim 13, wherein the information concerning a piece of real estate includes information concerning the characteristics of a piece of real estate.

15. The method of claim 11, further comprising interacting with a user via a graphical user interface including web pages.

16. The method of claim 11, further comprising automatically dialing a telephone using a telephone number associated with a contact in the database.

17. The method of claim 11, wherein a contact can include a person, a partnership or a company.

18. The method of claim 11, further comprising:
enabling a plurality of users to access the database;
wherein at least a portion of the information in the database is accessible to all users; and
wherein at least a portion of the information in the database is accessible to a defined subset of users.

19. The method of claim 11, further comprising:
enabling a plurality of users to access the database; and
providing a defined subset of users with the capability to modify the database.

20. An integrated real estate search engine and contact management system, comprising:
a server connected to a database;
wherein the database includes information concerning a piece of real estate;
wherein the database includes information concerning contacts;
wherein the database includes information concerning a relationship between a contact and another contact or a piece of real estate;
wherein the database includes information concerning a relationship between one contact and another contact;
wherein the information concerning contacts includes information concerning correspondence with contacts;
wherein the server is configured to provide an interactive user interface;
wherein interactive user interface is configured to enable searching of the database;
wherein the interactive user interface is configured to enable modification of the database.
